(19) United States
(12) Patent Application Publication
(10) Pub. No.: US 2024/0376800 A1
(43) Pub. Date: Nov. 14, 2024

(54) SYSTEM AND METHOD FOR DETERMINING VALVE OPENING AND CLOSING POSITIONS IN A DOWNHOLE CARD

(71) Applicant: WellWorx Energy Solutions LLC, Midland, TX (US)

(72) Inventors: Victoria M. Pons, Katy, TX (US); Jeremy M. Gomes, Houston, TX (US)

(21) Appl. No.: 18/660,625

(22) Filed: May 10, 2024

Related U.S. Application Data
(60) Provisional application No. 63/465,433, filed on May 10, 2023.

(51) Int. Cl. E21B 34/16; F16K 37/00

(52) U.S. Cl. CPC E21B 34/16; F16K 37/0083

(57) ABSTRACT

A method for determining valve opening and closing positions in a downhole card for an oil and gas well, the method including: calculating a downhole card using surface data for load and rod position; normalizing the load and position values for the downhole card; calculating a slope function data set using load and position; using a slope function to find start and end indexes along the downhole card; for each start and end index determining its percentage of vertical range and percentage of horizontal range; assigning the end index having the minimum horizontal range with the maximum vertical range as the standing valve opening point; assigning the start index having the maximum horizontal range with the maximum vertical range as the standing valve closing point; assigning the start index having the minimum horizontal range with the minimum vertical range as the traveling valve closing point.

### PRIORITY STATEMENT

This application claims priority of U.S. Provisional Patent Application No. 63/465,433, entitled “System and Method for Determining Valve Opening and Closing Positions in a Downhole Card,” filed May 10, 2023.

### BACKGROUND OF THE INVENTION

When a well's own energy is not enough to bring the produced fluids to the surface, an artificial lift system is needed to help lift the fluid from the wellbore. One of these methods is sucker rod pumps. In sucker rod pumps, the circular motion of crank at the surface is translated downhole to the pump using a polished rod and rod string.

Referring now to FIGS. 1, 1A and 1B, a diagram of a typical sucker rod pump used in oil wells is described. Well 10 includes well bore 11 and pump assembly 12. Pump assembly 12 is formed by a motor 13 that supplies power to a gear box 14. Gear box 14 is operable to reduce the angular velocity produced by motor 13 and to increase the torque relative to the input of motor 13. The input of motor 13 is used to turn crank 15 and lift counter weight 16. As crank 15 is connected to walking beam 17 via pitman arm 18, walking beam 17 pivots and submerges plunger 19 in well bore 11 using bridle 20 connected to walking beam 18 by horse head 21. Walking beam 17 is supported by Sampson post 22.

Well bore 11 includes casing 23 and tubing 24 extending inside casing 23. Sucker rod 25 extends through the interior of tubing 24 to plunger 19. At the bottom 25 of well bore 11 in oil bearing region 26, casing 23 includes perforations 27 that allow hydrocarbons and other material to enter annulus 28 between casing 23 and tubing 24. Gas is permitted to separate from the liquid products and travel up the annulus where it is captured. Liquid well products collect around pump barrel 29, which contains standing valve 30. Plunger 19 includes traveling valve 31. During the down stroke of the plunger, traveling valve 31 is opened and product in the pump barrel is forced into the interior of tubing 24. When the pump begins its upstroke, traveling valve 31 is closed and the material in the tubing is forced up the tubing by the motion of plunger 19.

In deep wells the long sucker rod has considerable stretch, distributed mass, etc., and motion at the pump end may be radically different from that imparted at the upper end. One method of determining pump performance involves plotting a curve of rod load versus displacement. The shape of the curve or “card” reflects the conditions which prevail downhole in the well. U.S. Pat. No. 3,343,409 describes a method for determining the downhole performance of a rod pumped well by measuring surface data, (the surface card) and computing a load versus displacement curve (a “pump card” for the sucker rod string at any selected depth in the well).

Examples of pump cards, also referred to as downhole cards, are shown in FIG. 2. The plot of load versus position shows the operating conditions of the well during a full pump stroke. In broad terms, the corners of the top of the plot show the standing valve opening and closing points and the bottom shows the travelling valve opening and closing points. The shape of the plot, particularly the right edge can be indicative of how completely the pump is filling during a full stroke. The plot can be used to alter the operating conditions of the well, such as by slowing down the rod cycle to increase the time for the pump to fill during a rod cycle.

The concepts described herein provide an accurate and robust way to calculate standing valve opening and closing, traveling valve opening and closing as well as pump fillage and fluid load.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a sucker rod pump used in oil wells, the sucker rod pump being positioned in a well bore and at an oil bearing region;

FIG. 1A depicts a portion of well bore taken about section 1A of FIG. 1;

FIG. 1B depicts a portion of oil bearing region taken about section 1B of FIG. 1;

FIGS. 2A through 2E each depict a downhole card;

FIG. 3 depicts a method of determining valve opening and closing points of the sucker rod pump of FIG. 1; and

FIG. 4 depicts a downhole card including normalized load and position vectors.

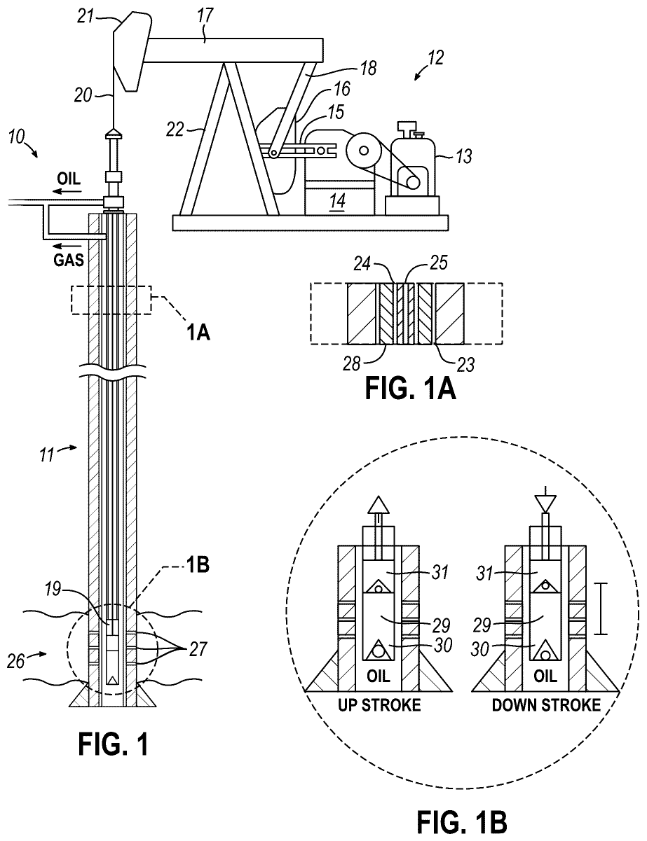

### DESCRIPTION OF THE INVENTION

There are three forces coming into play when using rod pumping: elasticity, viscous friction, and mechanical friction. Elasticity takes the form of stress waves traveling up and down the rod string at the speed of sound as the rod string material stretches and compresses with the cyclic motion of the pumping unit. Produced fluid being lifted to the surface creates a viscous force on the outer diameter of the rod string opposing its movement. Finally, either due to well deviation, paraffin or other external factors, the rod string and couplings cause mechanical friction with its contact with the inner diameter of the tubing.

In order to effectively control rod pumps, one must calculate not only the work done at the surface but also anticipate the energy losses to the system due to the above three conditions. The one-dimensional damped wave equation is used to calculate position and load at the pump using position and load measured at the surface. The 1D damped wave equation reads:

$${v}^{2} \frac{{\partial }^{2} u}{\partial {x}^{2}} = \frac{{\partial }^{2} u}{\partial {t}^{2}} + D \frac{\partial u}{\partial t} , \qquad ( 1 )$$

where the acoustic velocity is given by:

$$v = \sqrt{\frac{144 Eg}{ρ}} .$$

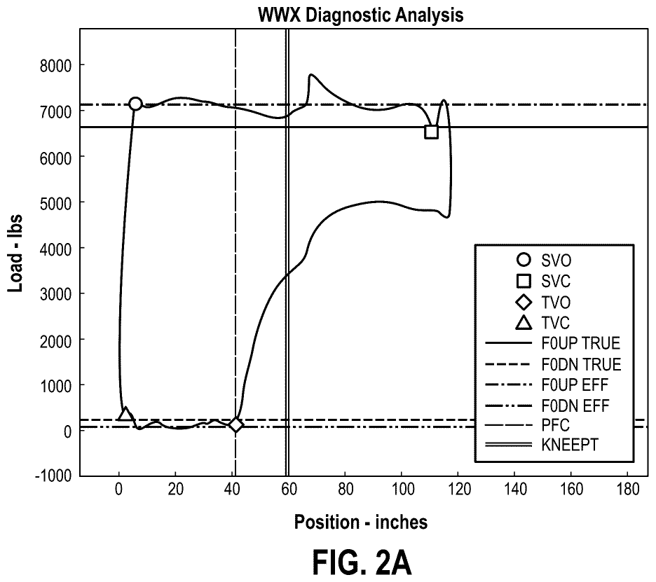

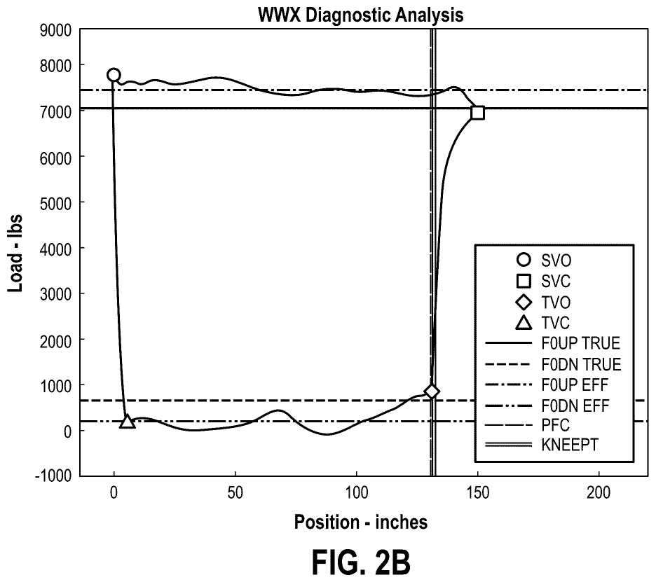

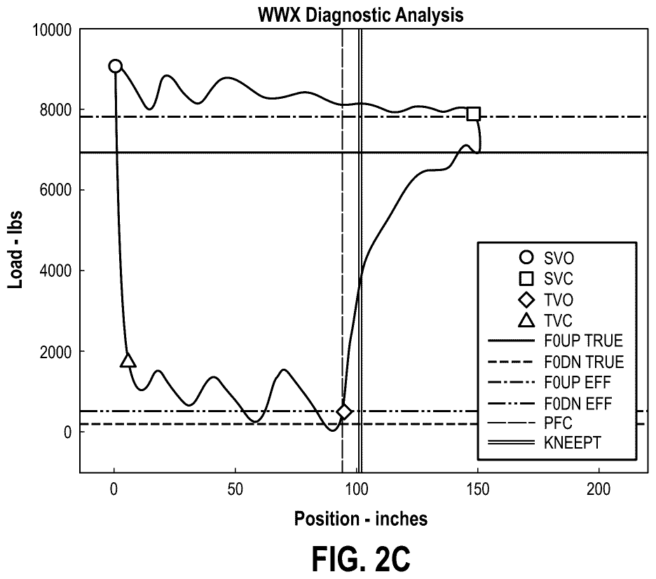

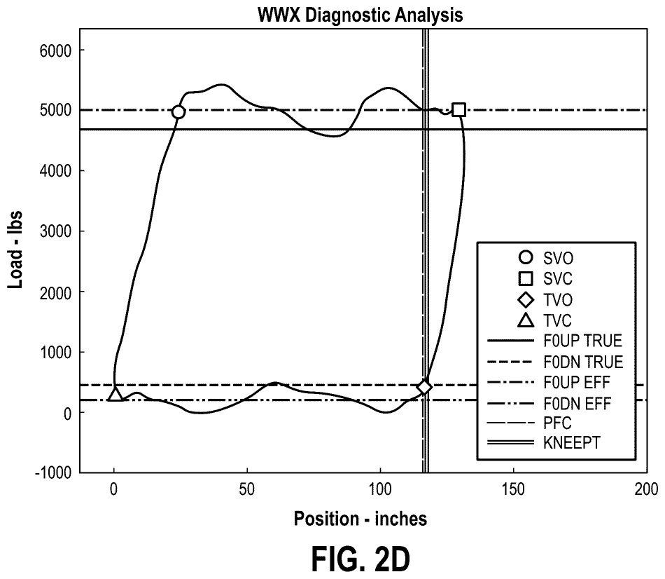

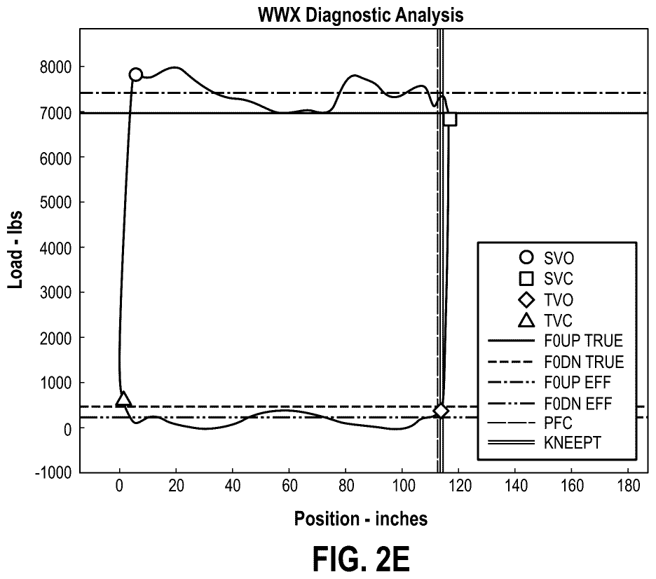

Once the downhole data is calculated, it can now represent a downhole card, examples of which are shown in FIGS. 2A through 2E. Essential quantities can be extracted from the downhole data to diagnose, interpret, and modify control of the well and fluid extraction. Such quantities include but are not limited to pump fillage and fluid load, as well as valve opening and closing points.

Pump fillage represents the percentage of plunger capacity filled for that stroke. Pump fillage varies between 0 and 100. When the pump fillage is 100, the card is considered full, and the plunger is considered at full capacity. When the pump fillage is less than 100, the well is considered to be pumped off and should be slowed down or stopped to allow fluids from the reservoir to fill the wellbore. Pump fillage can be represented as the horizontal span of the downhole card.

Fluid load means the weight in pounds (lbs.) of the fluid being lifted. This quantity varies from well to well. Fluid load can be represented by the vertical span of the downhole data or card. Downhole conditions and external factors can affect the downhole card and complicate the calculation of fluid load.

Knowing where the standing valve and traveling valve open and close is key to an accurate calculation of the pump fillage and fluid load. At the beginning of the upstroke, the rods stretch as the pumping unit pulls up, then the standing valve opens to allow fluid in from the wellbore. Right before the top of stroke or at the top of stroke, the standing valve closes. As the pumping unit comes back down, the rods compress back to their original length and position and the traveling valve opens to release the produced fluids in the tubing. At the end of the downstroke, the traveling valve closes and the cycle begins anew.

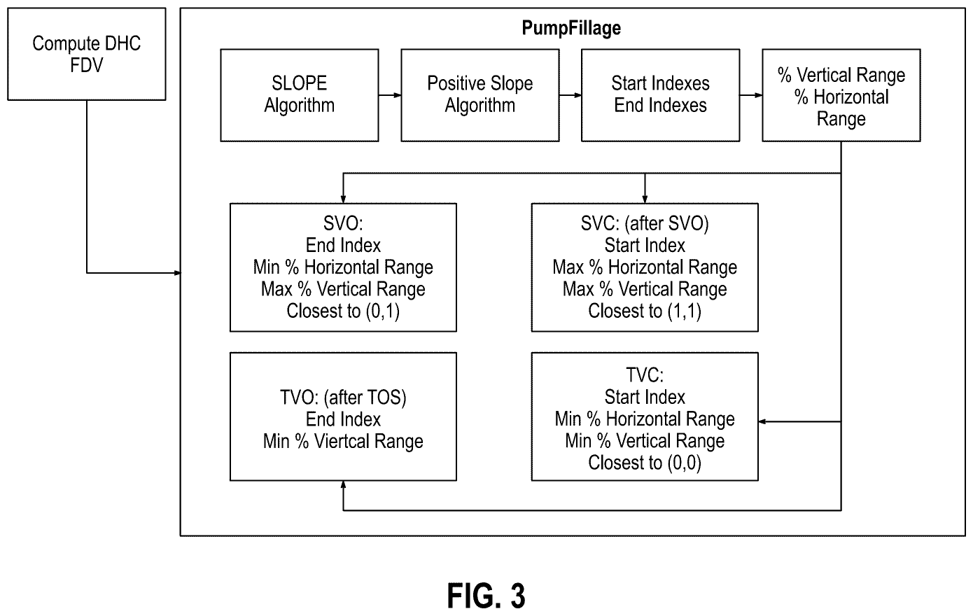

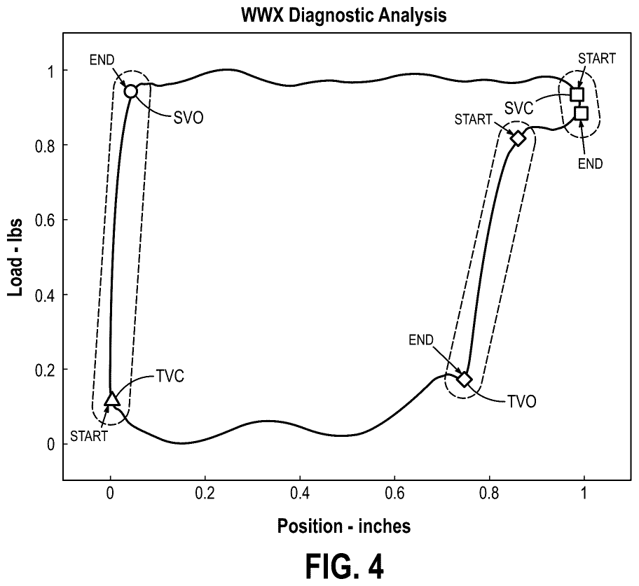

Referring now to FIG. 3, a diagram of a method to determine valve opening and closing points is shown with reference to the downhole card shown in FIG. 4. The method begins by computing the downhole card from surface data. The top of stroke (TOS) is found as the maximum position span or x-axis. The load and position vectors are normalized so that each minimum value is 0 and maximum value is 1, as shown in FIG. 4.

Next the slope vectors data set is calculated by dividing the downhole loads by the downhole position and a slope vector analysis is performed to yield start indexes and end indexes. The slope vector data set can be used to infer periods of rapid vertical growth in the downhole data, identified by data showing a positive slope above a predetermined threshold. The line segments identified by the dotted lines show segments of rapid vertical growth. The start indexes for these segments are shown as start points in FIG. 4 and the end indexes are shown as end points. For each start point and each end point, the percentage of vertical range and percentage of horizontal range is calculated. Once percentages of vertical and horizontal range are known for each point we can assign particular points as valve opening or closing points.

The standing valve opening (SVO) is assigned to the end index point having the minimum value of horizontal range (x-axis) with the maximum value of vertical range (y-axis), which is the point closest to (0,1) in our normalized downhole card. The standing valve closing (SVC) is assigned to the start index point having the maximum value of horizontal range (x-axis) with the maximum value of vertical range (y-axis), which is the point closest to (1,1) in our normalized downhole card. The traveling valve closing (TVC) is assigned to the start index point having the minimum value of horizontal range (x-axis) with the minimum value of vertical range (y-axis), which is the point closest to (0,0) in our normalized downhole card. Finally, the traveling valve opening (TVO) is assigned to the end index point having the minimum value of vertical range (y-axis) with the minimum percentage of vertical range between the top of stroke and the traveling valve closing point.

Once we have identified these points on the downhole card they can be used to calculate both pump fillage and fluid load.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining valve opening and closing positions in a downhole card for an oil and gas well, the method comprising:
calculating a downhole card using surface data for load and rod position;
normalizing the load and position values for the downhole card;
calculating a slope function data set using load and position;
using a slope function to find start and end indexes along the downhole card;
for each start and end index determining its percentage of vertical range and percentage of horizontal range;
assigning the end index having the minimum horizontal range with the maximum vertical range as a standing valve opening point;
assigning the start index having the maximum horizontal range with the maximum vertical range as a standing valve closing point;
assigning the start index having the minimum horizontal range with the minimum vertical range as a traveling valve closing point;
assigning the end index having the minimum vertical range between a top of stroke and the traveling valve closing point as a traveling valve opening point.

2. The method of claim 1, further comprising operating the oil and gas well for at least one full rotation of a crank of the oil and gas well, the crank defining the top of stroke.

3. The method of claim 2, further comprising operatively connecting the rod to the crank to thereby change the load and rod position during the at least one full rotation of the crank.

4. The method of claim 3, further comprising recording the load and rod position during the at least one full rotation of the crank to thereby generate the surface data.

5. The method of claim 1, further comprising transitioning a traveling valve attached to a rod of the oil and gas well between an open position and a closed position.

6. The method of claim 5, further comprising using the traveling valve in the open position to assign the traveling valve opening point and using the traveling valve in the closed position to assign the traveling valve closed point.

7. The method of claim 1, further comprising transitioning a standing valve of the oil and gas well between an open position and a closed position to thereby assign the standing valve opening point and the standing valve closing point, respectively.

8. The method of claim 1, further comprising translating a plunger of the oil and gas rig between a high position and a low position to thereby generate the surface data.

9. The method of claim 8, the standing valve closing point and the traveling valve opening point being more representative of the high position of the plunger than the standing valve opening point and the traveling valve closing point.

10. The method of claim 8, the standing valve opening point and the traveling valve closing point being more representative of the low position of the plunger than the standing valve closing point and the traveling valve opening point.

11. A method for determining valve opening and closing positions in a downhole card for an oil and gas well, the method comprising:
operating the oil and gas well for at least one full rotation of a crank of the oil and gas well to thereby translate a rod of the oil and gas well, the crank defining a top of stroke;
calculating a downhole card using surface data for load and rod position of the rod;
calculating a slope function data set using load and position;
using a slope function to find start and end indexes along the downhole card;
for each start and end index determining its percentage of vertical range and percentage of horizontal range;
assigning the end index having the minimum horizontal range with the maximum vertical range as the standing valve opening point;
assigning the start index having the maximum horizontal range with the maximum vertical range as the standing valve closing point;
assigning the start index having the minimum horizontal range with the minimum vertical range as the traveling valve closing point;
assigning the end index having the minimum vertical range between the top of stroke and the traveling valve closing point as the traveling valve opening point.

12. The method of claim 11, further comprising operating the oil and gas well for at least two full translations of a plunger operatively connected to the rod.

13. The method of claim 12, further comprising transitioning each of a travel valve and a standing valve between an open position and a closed position.

14. The method of claim 13, further comprising recording the load and rod position during the at least one full rotation of the crank to thereby generate the surface data.

15. The method of claim 11, further comprising transitioning a traveling valve attached to a rod of the oil and gas well between an open position and a closed position.

16. The method of claim 15, further comprising using the traveling valve in the open position to assign the traveling valve opening point and using the traveling valve in the closed position to assign the traveling valve closing point.

17. The method of claim 11, further comprising transitioning a standing valve of the oil and gas well between an open position and a closed position to thereby assign the standing valve opening point and the standing valve closing point, respectively.

18. The method of claim 11, further comprising translating a plunger of the oil and gas rig between a high position and a low position to thereby generate the surface data.

19. The method of claim 18, the standing valve closing point and the traveling valve opening point being more representative of the high position of the plunger than the standing valve opening point and the traveling valve closing point.

20. A method for determining valve opening and closing positions in a downhole card for an oil and gas well, the method comprising:
calculating a downhole card using surface data for load and rod position of the rod;
calculating a slope function data set using load and position;
using a slope function to find start and end indexes along the downhole card;
for each start and end index determining its percentage of vertical range and percentage of horizontal range;
assigning the end index having the minimum horizontal range with the maximum vertical range as the standing valve opening point;
assigning the start index having the maximum horizontal range with the maximum vertical range as the standing valve closing point;
assigning the start index having the minimum horizontal range with the minimum vertical range as the traveling valve closing point;
assigning the end index having the minimum vertical range between a top of stroke and the traveling valve closing point as the traveling valve opening point.
